(19) United States
(12) Patent Application Publication
(10) Pub. No.: US 2019/0301231 A1
(43) Pub. Date: Oct. 3, 2019

(54) AUTOMATIC VEHICLE CLOSURE SYSTEM

(71) Applicants: Azhagu SUBRAMANIAN, Troy, MI (US); Frank GABBIANELLI, Birmingham, MI (US); Timothy REABURN, Windsor (CA); Benjamin SALTSMAN, Bloomfield Township, MI (US); Joel STIVERSON, St. Clair Shores, MI (US); MAGNA INTERNATIONAL INC., Aurora (CA); Todd DEAVILLE, Markham (CA)

(72) Inventors: Frank GABBIANELLI, Birmingham, MI (US); Todd DEAVILLE, Markham (CA); Timothy REABURN, Windsor (CA); Benjamin SALTSMAN, Bloomfield Township, MI (US); Joel STIVERSON, St. Clair Shores, MI (US); Azhagu SUBRAMANIAN, Troy, MI (US); Warren YOUNG, Troy, MI (US)

(21) Appl. No.: 16/316,066

(22) PCT Filed: Jul. 29, 2017
(86) PCT No.: PCT/US17/44553

§ 371 Date: Jan. 8, 2019

Related U.S. Application Data
(60) Provisional application No. 62/363,071, filed on Jul. 15, 2016.

(51) Int. Cl. E05F 15/73; B60J 5/10; E05F 15/652; E05F 15/655

(52) U.S. Cl. CPC E05F 15/73; B60J 5/102; E05F 15/652; E05F 2015/767; E05Y 2201/434; E05Y 2900/546; E05F 15/655

(57) ABSTRACT

A system for opening and closing a closure of a vehicle, such as a door or a tailgate, is provided. The system includes a motor such as an electric motor which may be coupled to the closure via an output linkage, with the output linkage mechanically coupled to the closure and operable to move the closure between a closed position and an open position. The output linkage may include a driven pulley which may be coupled to the motor. The output linkage may include a driven pulley and a cable. The output linkage may include a leadscrew threadedly engaging a nut. A high-bandwidth MR clutch having a high dynamic response may selectively couple the motor with the closure to provide a haptic or tactile feedback to a user interacting with the closure as it is opened or closed.

### CROSS REFERENCE TO RELATED APPLICATIONS

This PCT International Patent Application claims the benefit of U.S. Provisional Patent Application Ser. No. 62/368,590 filed Jul. 29, 2016 entitled “Tailgate Operation System,” and U.S. Provisional Patent Application Ser. No. 62/510,027 filed May 23, 2017 entitled “Automatic Vehicle Closure System,” the entire disclosures of the applications being considered part of the disclosure of this application and hereby incorporated by reference.

### BACKGROUND

Power actuated vehicle closures such as doors, tailgates, and liftgates are provided in a variety of vehicles such as mini-vans and sport utility vehicles, and may be available as an upgrade or included in a premium package, which can be highly profitable for a vehicle manufacturer. Tailgates are provided on many vehicles, such as pickup trucks and sport utility vehicles, for providing access to cargo areas and to aid in loading and unloading items or cargo from the vehicle. Power actuated or power assisted doors and liftgates are popular options for people who frequently have many items to load and unload from their vehicle, such as parents of small children. Power actuated or power assisted doors and liftgates are especially useful for persons who lack the physical stature or strength to easily open and close a vehicle door or liftgate manually.

Pickup trucks and sport utility vehicles have been increasingly popular and now account for a substantial percentage of new vehicle sales. There is a large and growing market for vehicles that include upgraded or premium features and fixtures, which may include power assisted or power actuated components, particularly ones with precise control that requires minimal effort to use.

### SUMMARY

A system for opening and closing a closure of a vehicle is disclosed and includes a motor coupled to the closure through an output linkage to move the closure between a closed position and an open position and a high-bandwidth clutch having a high dynamic response selectively coupling the motor with the closure.

According to one exemplary embodiment, the vehicle closure may be a tailgate. According to another exemplary embodiment, the closure may be a hinged door. The system may also be used with other types of vehicle closures such as, for example, a sliding door or window or a liftgate style tailgate as is commonly provided on minivans, hatchbacks, and sport utility vehicles. A motor, such as an electric motor, may utilize gearing to achieve desired output RPM and may be selectively coupled to the vehicle closure by a clutch such as a magneto-rheological clutch, commonly called an MR clutch, and through an output linkage which is mechanically coupled to the vehicle closure and is operable to move the vehicle closure between a closed position and an open position in either an opening or a closing direction. The output linkage may include a driven pulley that is selectively coupled to the electric motor by the MR clutch. The output linkage may also include a leadscrew threadedly engaging a nut to generate a linear force therebetween. The leadscrew may be provided with a long lead of 50-60 mm per revolution to reduce the rotational speed required to open or close the closure. The use of a leadscrew may provide the advantage of reducing the backlash in the system when compared to other types of output linkages.

According to an aspect, the system may include a pressure sensor to generate a signal used by an actuator controller to move the vehicle closure between an open position and a closed position in response to the touch of a user. The pressure sensor may measure the force applied by a user and cause the vehicle closure to move in response to the force applied by the user. As the user follows the vehicle closure with his or her hand, the force applied to the tailgate may be continuously adapted to maintain a predetermined force on the user's hand. Because the high-bandwidth clutch can provide a high dynamic response, the user may feel a light load as he/she operates the vehicle closure. In this way, the system may respond to small changes in velocity of the closure and may provide a haptic or tactile feedback to the user who may perceive the vehicle closure as having a very light weight. Such a system may be characterized as providing a power-assist function in moving the vehicle closure. A similar process may also be used to open the vehicle closure.

### DESCRIPTION OF THE DRAWINGS

The detailed description refers to the following drawings, in which like numerals refer to like items, and in which:

FIG. 1 is a side view of a truck showing the field of view of a rear-view camera;

FIG. 2 is a cut-away side view of a segment of a body of a truck with a drop-style tailgate having a cable attached to a side thereof;

FIG. 3A is a cut-away side view of a segment of a body of a truck with a drop-style tailgate in accordance with an aspect of the disclosure and in a closed position;

FIG. 3B is a cut-away side view of a segment of the body of the truck and the tailgate of FIG. 3A in a closed position;

FIG. 4 is a side view of a vehicle having a liftgate style tailgate and including a system for automatically opening and closing the tailgate;

FIG. 5 is a perspective view of a truck showing a tailgate with a pressure sensor;

FIG. 6A is a cut-away perspective view of a segment of a body of a truck with a drop-style tailgate in accordance with an aspect of the disclosure and in a closed position;

FIG. 6B is a cut-away perspective view of the segment of the body of the truck and the tailgate of FIG. 6A in an intermediate position;

FIG. 6C is a cut-away perspective view of the segment of the body of the truck and the tailgate of FIG. 6A in an open position;

FIG. 7 is a cut-away perspective view of a segment of a body of a truck with a drop-style tailgate in accordance with another aspect of the disclosure and in a closed position;

FIG. 8A is a is a cut-away side view of a segment of a body of a truck with a drop-style tailgate in accordance with a further aspect of the disclosure and in a closed position;

FIG. 8B is a cut-away side view of a segment of the body of the truck and the tailgate of FIG. 8A in an open position

FIG. 9A is a cut-away side view of a segment of a vehicle body and a side door;

FIG. 9B is an enlarged cut-away side view of the vehicle body and side door of FIG. 9A; and

FIG. 9C is an enlarged cut-away top view of the vehicle body and side door of FIG. 9A.

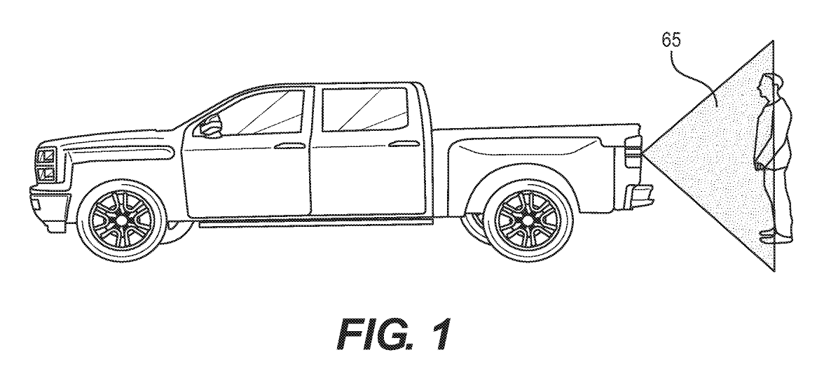

### DETAILED DESCRIPTION OF THE EXAMPLE EMBODIMENTS

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g., XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience. Unless otherwise stated, any reference to moving between two or more different positions should be construed as including moving in either direction from one position to another position or vice-versa.

Referring to the Figures, wherein like numerals indicate corresponding parts throughout the several views, a system 10 for opening and closing a closure of a vehicle is disclosed. The system 10 may react to a user input, which may be, for example, a touch or other pressure applied to the closure or the press of a button on the vehicle or on a remote device such as a key fob. The user input may also be gesture based and may be sensed by a camera located on the vehicle. The system 10 may then actuate the closure to move between its opened and closed positions or vice-versa. The system 10 may respond to small changes in the velocity of the closure as it is being opened or closed and may provide very precise control of the motion of the closure sufficient to provide haptic or touch feedback. In this way, the system 10 may enable a closure to operate in a power-assist mode in which the user may perceive the closure as having a very light weight.

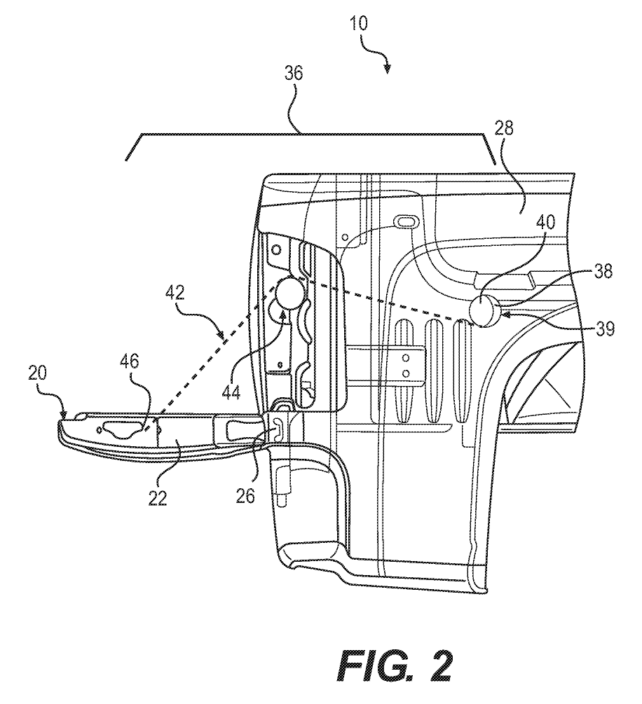

As shown in FIG. 2, the closure may include a tailgate 20 having a generally rectangular shape with a two sides 22 spaced and parallel to one another with a bottom edge (not shown) extending perpendicularly therebetween and with a hinge 26 connecting the tailgate 20 to the body 28 of the vehicle and movable between a closed position with a generally vertical orientation and an open position with a generally horizontal orientation about an axis running horizontally and transverse to the body 28 of the vehicle. The axis may be adjacent and parallel to the bottom edge, for use with a drop-style tailgate, as is commonly provided on a pickup truck. The axis may be adjacent and parallel to the top of the body, for use in a liftgate style tailgate, as is commonly provided on hatchbacks, minivans, and sport utility vehicles. A motor (not shown), which may be an electric motor, may use gearing to turn an output shaft at a desired output RPM and may be selectively coupled to the tailgate 20 via an output linkage 36 and through a clutch 38. The clutch 38 may be a high-bandwidth clutch 38 having a high dynamic response which may be, for example, greater than 10 Hz. More specifically, the clutch 38 may provide a dynamic response of 25 Hz or higher. A separate gearbox (not shown) having an output shaft may couple the motor to the output linkage 36. The motor may be a compact motor with a high output speed, which may be, for example, 10,000 to 20,000 RPM. The gearbox may reduce the motor speed by a predetermined ratio, which may be, for example, a factor of 50, and thereby increase the output torque. In a preferred embodiment, the motor may be an electric motor operating at a nominal speed of 15,000 RPM and the gearbox may reduce the output speed to 300 RPM. The clutch 38 may be controllable by varying one or more properties of a fluid, which may be a magnetorheological (MR) fluid that varies in viscosity due to an applied magnetic field. Alternatively, a stepper motor, which may or may not include gearing, may directly actuate the linkage mechanism without a clutch 38. The motor, together with the gearbox and the clutch, may collectively be called a power actuator 39.

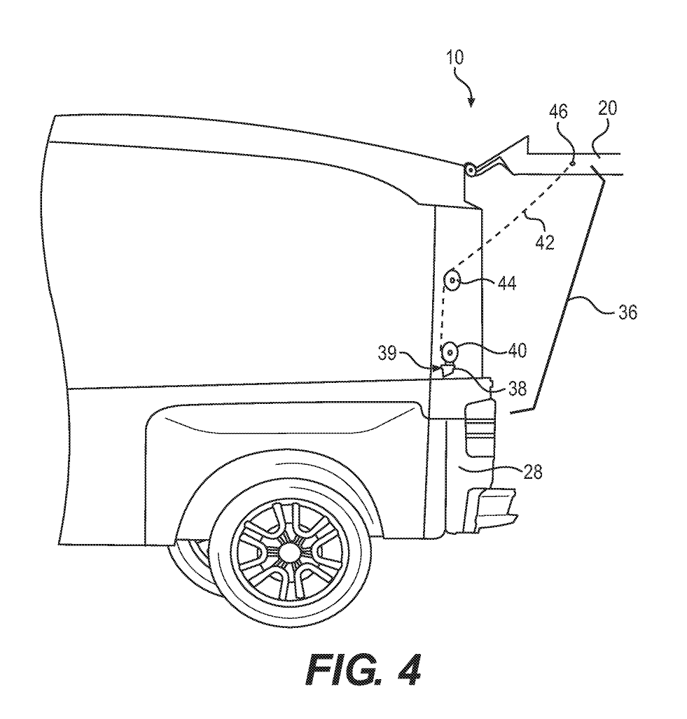

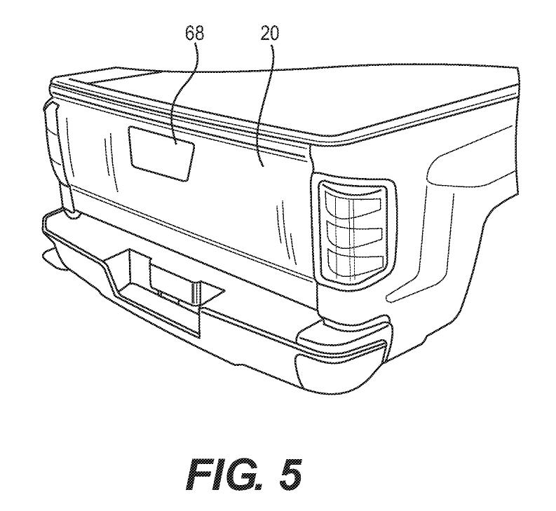

The output linkage 36 may be substantially or completely disposed within the body 28 of the vehicle, which may leave the area above and beside the tailgate 20 unobstructed, providing a cleaner, more attractive look and providing for easier access onto the tailgate 20 and into the vehicle when compared with prior art designs that include cables or linkages between the sides of the tailgate and the body of the vehicle. The system of the present invention may allow a tailgate 20 to be provided without a physical handle, allowing for a cleaner and more attractive style. It should be noted that the arrangement shown in FIGS. 2, 3A, 3B, and 4 may be reversed with the power actuator 39 packaged within the tailgate or liftgate.

According to an aspect and as shown in FIG. 2, the output linkage 36 may be mechanically coupled to the tailgate 20 and operable to move the tailgate 20 between the closed position and the open position in either an opening or a closing direction. The output linkage 36 may include a driven pulley 40 that is fixed to rotate with the output shaft with the clutch 38 in an engaged position and rotatable independent of the output shaft with the clutch 38 in a disengaged position. The clutch 38 may be adjusted to a plurality of intermediate positions between its engaged and disengaged positions, in which the driven pulley 40 is partially coupled to rotate with the output shaft but not fully fixed thereto, so the driven pulley 40 may rotate at the same speed or at a different speed than the output shaft. A cable 42 may be attached to and configured to wind around the driven pulley 40 and also attached to the tailgate 20 to move the tailgate 20 between the closed position and the open position with the driven pulley 40 being rotated by the motor. An idler pulley 44 may be disposed between the driven pulley 40 and the tailgate 20 with the cable 42 extending from the driven pulley 40 and over the idler pulley 44 to an end 46 coupled to one of the sides 22 of the tailgate 20 and spaced apart from the bottom edge to move the tailgate 20 between the open position and the closed position. A spring (not shown) may bias the tailgate 20 toward the open position and may oppose the pulling force of the cable 42, which may bias the tailgate 20 toward the closed position. The spring may include, for example, a gas cylinder or a clock spring or a torsion spring. Alternatively, the pulling force of the cable 42 may bias the tailgate 20 toward the open position. The spring may bias the tailgate 20 through its full range of travel between the closed position and the open position. Alternatively, the spring may bias the tailgate 20 for a portion of its full range of travel between the closed position and the open position, with gravity also pulling the tailgate 20 downward.

A stopper (not shown) may be attached to the cable 42 between the tailgate 20 and the driven pulley 40 for absorbing the force of an abuse load on the tailgate 20. The term “abuse load” includes any force beyond the weight of the tailgate 20 itself being moved in a gentle and controlled manner. An abuse load may include slamming the tailgate 20 toward its open or closed position, or any external weight placed on the tailgate 20 in any position, such as a person standing tailgate 20 or the weight of cargo placed or dropped upon the tailgate 20, such as when the cargo is loaded or unloaded from the vehicle. The cable 42 may include different segments with a first segment having a higher load carrying capacity and a second segment having a lower load carrying capacity and with the first segment being nearest to the tailgate 20 and the second segment being nearest to the driven pulley 40. In this way, the tailgate 20 with any abuse load may be supported by the first segment having a higher load carrying capacity, which may be transferred away from the second segment, such as through the stopper. The second segment having a lower load carrying capacity may also have characteristics that make it better for winding upon the driven pulley 40, such as a smaller diameter or a lower stiffness.

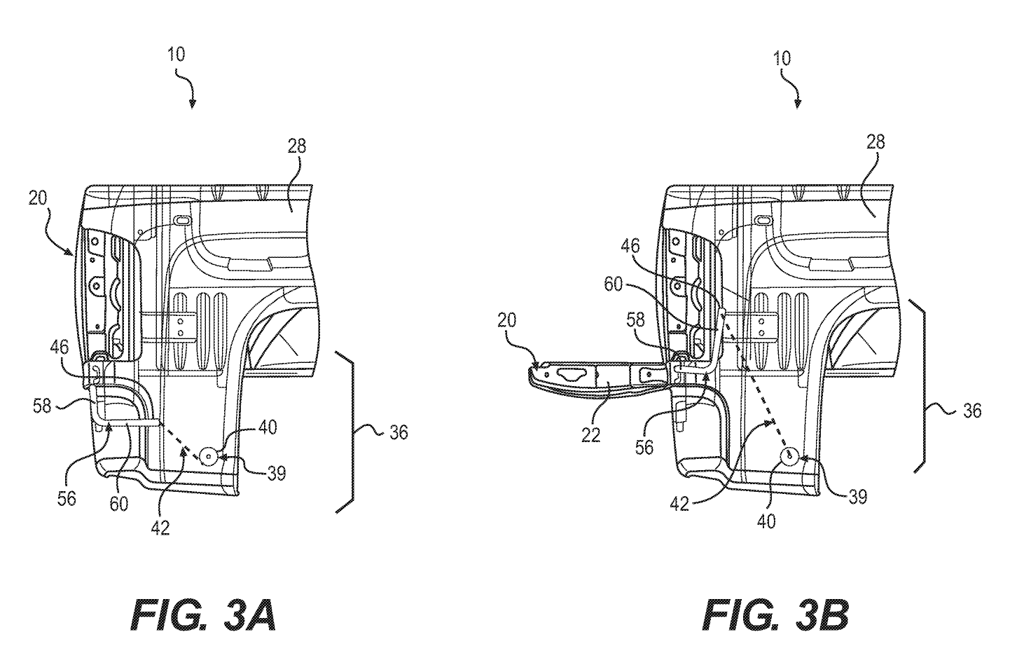

According to another aspect and as shown in FIG. 3, the system 10 may include a lever 56 extending from the tailgate 20 parallel and adjacent to one of the sides 22. The lever 56 may have an L-shape with a first leg 58 extending in-line with the tailgate 20 and beyond the hinge 26 and with a second leg 60 generally perpendicular thereto and in an upright orientation with the tailgate 20 in the open position. In this way, the lever 56 may be enclosed by the body of the vehicle to provide an unobstructed area above the sides 22 of the tailgate 20, allowing a user to place objects on or over the sides 22 of the tailgate 20. A bump-stop (not shown) may be made of rubber or polyurethane or other suitable energy absorbing material and may be disposed on the lever 56 for absorbing the force of an abuse load on the tailgate 20. Alternatively, the bump-stop may be disposed on the body of the vehicle to engage the lever 56 for absorbing the force of an abuse load on the tailgate 20. According to an aspect, the cable 42 may extend from the driven pulley 40 to an end 46 coupled to the second leg 60 opposite the first leg 58 to move the tailgate 20 between the open position and the closed position.

According to an aspect, the system 10 may further including a rear-view camera (not shown) having a field of view 65 behind the vehicle and configured to provide an image to a controller for object classification and motion detection. The rear-view camera may be configured to recognize gestures within the field of view 65 and to provide a signal for an actuator controller to operate the electric motor and selectively engage the clutch 38 to move the tailgate 20 between the open position and the closed position in response to a predetermined gesture.

According to an aspect, the system 10 may further include a pressure sensor 68 on the tailgate 20 to generate a signal used by the actuator controller to operate the electric motor and selectively engage the clutch 38 to move the tailgate 20 between an open position and a closed position in response to the touch of a user. Such a pressure sensor 68 may take the place of a traditional handle on tailgates 20 of the prior art and be located in the center of the tailgate. Alternatively, one or two of such sensors may be located on either end of the tailgate to enable easier operation of the tailgate when the center of the tailgate is obstructed, such as when a trailer is hooked to the vehicle or a rack is affixed to a trailer hitch on the vehicle.

In operation, the pressure sensor 68 may measure the force applied by a user and cause a first signal to be transmitted to signal the electric motor to rotate. The clutch 38 may also be engaged in response to a second signal generated in response to the force applied by a user as determined by the pressure sensor 68. The combination of the rotation of the electric motor and the engaging of clutch 38 causes the driven pulley 40 to rotate, which in turn winds-up the cable 42, lifting the tailgate 20. As the user follows the tailgate 20 with his hand, the magnetic force on the clutch 38 may be continuously adapted to maintain a predetermined force on the user's hand.

According to a further aspect, the system 10 may react to a user's application of force on the tailgate 20 without using a pressure sensor. For example, the system 10 may respond to the angular location of the tailgate 20, which may be sensed by an encoder. In this way, the system 10 may detect the external application of force as a difference from a typical force of the tailgate 20 including the force of gravity and forces resulting from motion at a given position and at a given velocity and/or acceleration. The system 10 may determine the typical force by reference to a calculated or predefined relationship, e.g. by reference to a look-up table, which may provide typical forces that result from a given angular location of the tailgate 20 and torque output of the clutch 38.

The system 10 may include anti-pinch functionality, which may cause the actuator controller to stop or to reverse direction of the closure in response to a detected obstruction while the closure is being opened or closed. Obstruction detection for such anti-pinch functionality may use the pressure sensor 68, feedback from the electric motor, feedback from the clutch 38, another sensor or sensors, or any combination thereof.

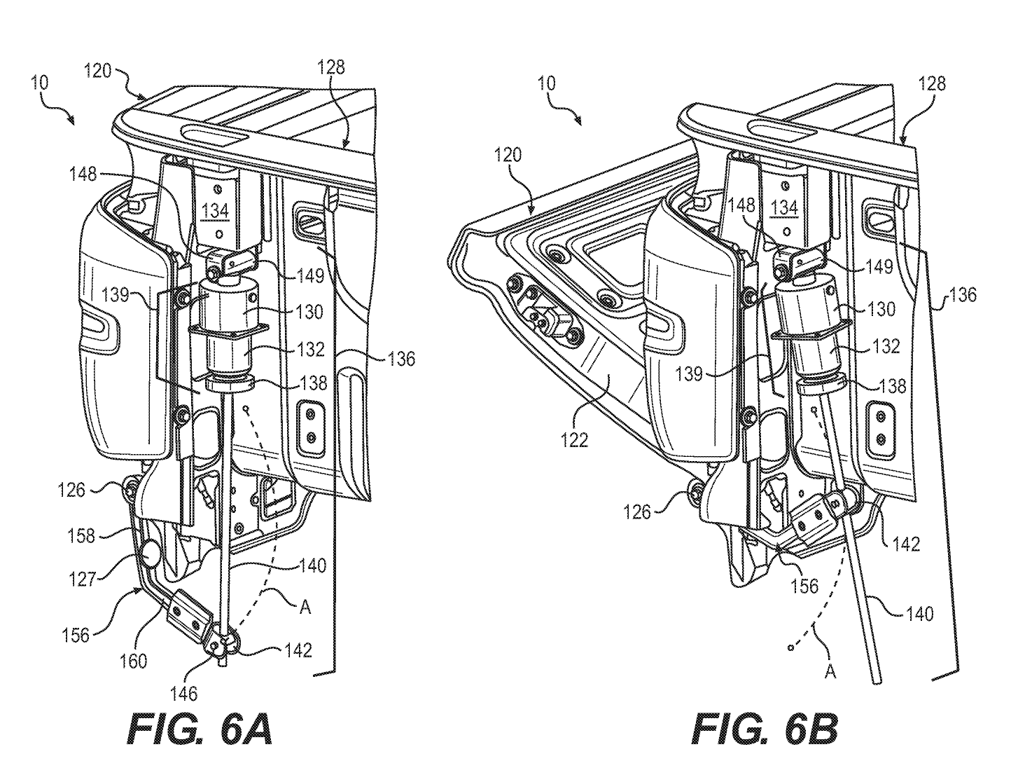

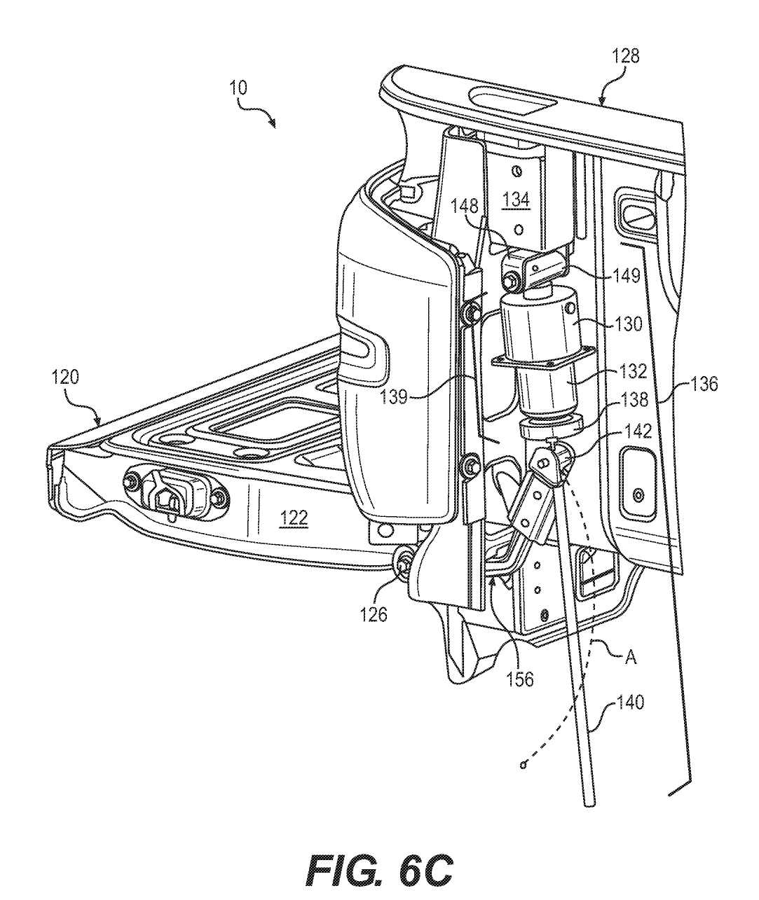

According to an aspect, and as shown in FIGS. 6A-6C, 7, 8A-8B, and 9A-9C, the system 10 may include a power actuation mechanism 136 including a motor 130 to turn a leadscrew 140 that rotates and threadedly interacts with a nut 142 to apply a linear force therebetween. The leadscrew 140 may be formed with a high lead which may allow the leadscrew 140 to rotate a relatively low number of rotations to move the vehicle closure through its full range of travel. Specifically, the leadscrew 140 may have a lead 50 to 60 mm per revolution, and may rotate about 5 to 6 rotations through its full range of travel. Such a configuration with a relatively low number of rotations required may reduce the opening and closing time and enable easier backdrive capability.

The power actuation mechanism 136 may include a gearbox 132 to reduce the rotational speed from the motor 130. The motor 130 may be a compact motor with a high output speed, which may be, for example, 10,000 to 20,000 RPM, and more specifically may operate at a nominal speed of 15,000 RPM. The gearbox 132 may reduce the output speed of the motor 130 by a predetermined ratio, which may be, for example, a factor of 50, and thereby increase the output torque. The motor, together with the gearbox and the clutch, may collectively be called a power actuator 139.

The power actuation mechanism 136 may also include a clutch 138 to selectively couple the motor 130 to the leadscrew. The clutch 138 may be a high-bandwidth clutch 138 having a high dynamic response which may be, for example, greater than 10 Hz. More specifically, the clutch 138 may provide a dynamic response of 25 Hz or higher. The clutch 138 may be a high bandwidth clutch that can output a high bandwidth torque. The clutch 138 may be controllable by varying one or more properties of a fluid, which may be a magnetorheological (MR) fluid that varies in viscosity due to an applied magnetic field. The clutch 138 may be controlled by a high frequency pulse signal, such as a pulse width modulation (PWM) signal and may have a high bandwidth to quickly change the viscous drag up to a locked condition with the output fixed to rotate with the input. Such a high-bandwidth clutch 138 may isolate the output from the input such that rotational inertia of the motor 130 and/or the gearbox 132 is not transferred to the output and may greatly improve the haptic feedback for a user in moving the vehicle closure in a “power-assist” mode.

The clutch 138 may default in an unpowered state to an open or isolated condition. An alternative arrangement with a normally closed clutch is also feasible. The clutch 138 may allow the vehicle closure to be manually operated without being impacted by drag forces due to the motor 130 or the gearbox 132. With the clutch 138 in a fully activated, or locked condition, and with the motor 130 stationary, the power actuation mechanism 136 may function to hold or to lock the vehicle closure in a desired position. For example, the power actuation mechanism 136 may function to securely hold a tailgate 120 in the opened position which may prevent it from vibrating or bouncing as the vehicle is driven. The holding function of the power actuation mechanism 136 may provide an “infinite check” feature, allowing the closure, which may be a side door 116, to be stopped and held at any intermediate position between fully closed and fully opened. Such an “infinite check” feature may provide improved feel and functionality over fixed detents commonly used in current vehicles.

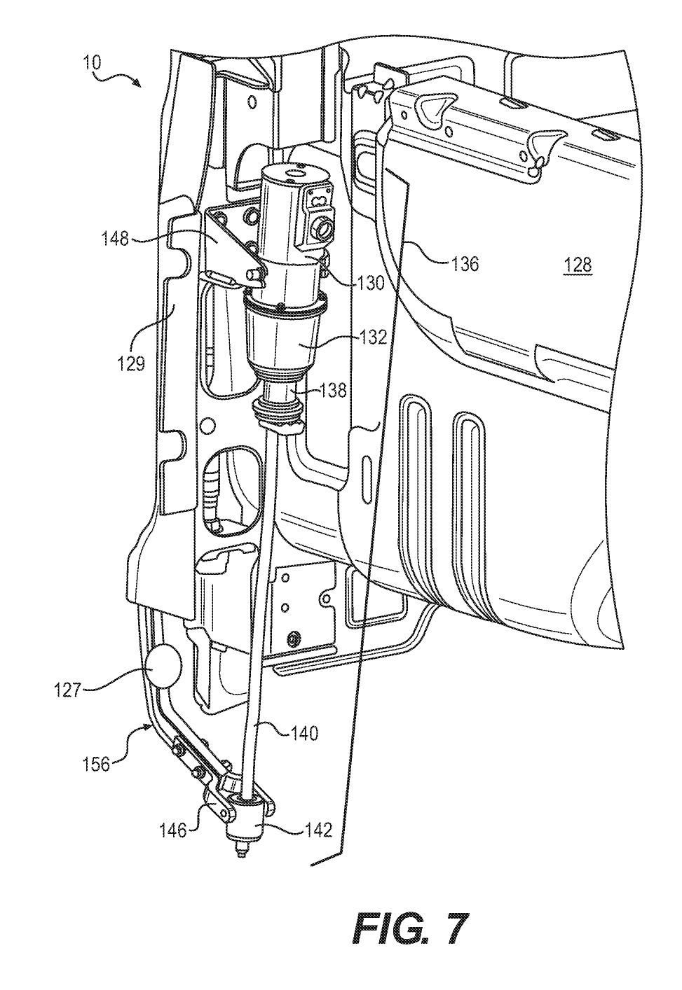

As shown in FIGS. 6A, 6B, 6C, and 7, the closure may include a tailgate 120 having a generally rectangular shape with a two sides 122 spaced and parallel to one another with a bottom edge (not shown) extending perpendicularly therebetween and with a hinge 126 connecting the tailgate 120 to the body 128 of the vehicle and movable between a closed position with a generally vertical orientation and an open position with a generally horizontal orientation about an axis running horizontally and transverse to the body 128 of the vehicle.

As shown in FIGS. FIGS. 6A, 6B, and 6C, the system 10 may include a lever 156 extending from the tailgate 120 parallel and adjacent to one of the sides 122. The lever 156 may have an L-shape with a first leg 158 extending in-line with the tailgate 120 and beyond the hinge 126 and with a second leg 160 generally perpendicular thereto and in an upright orientation with the tailgate 120 in the open position. In this way, the lever 156 may be enclosed by the body of the vehicle to provide an unobstructed area above at least one of the sides 122 of the tailgate 120, allowing a user to place objects on or over the side 122 of the tailgate 120. A reaction plate 127 may be affixed to the lever 156 and may interact with the bump-stop (not shown) which may be fixed to the body 128 for absorbing the force of an abuse load on the tailgate 120. Alternatively, the bump-stop may be disposed on the lever 156 to engage the body 128 for absorbing the force of an abuse load on the tailgate 20. According to an aspect, the leadscrew 140 may interact with a nut 142 attached to an end 146 of the lever 156 opposite the tailgate 120. The end 146 may attached to the lever 156, and may extend straight beyond the second leg 160 as shown in FIG. 7. Alternatively, the end 146 may be integrally formed with the arm 156. The end 146 may also include a bend to extend at an angle to the second leg 160 of the lever 156. As shown in FIG. 7, the end 146 may be formed as a clevis for holding the nut 142 and allowing the nut 142 to pivot as it follows an arcuate path A as the power actuation mechanism 136 moves the tailgate 120 between the closed and opened positions.

As shown in FIGS. 6A, 6B, and 6C, the power actuation mechanism 136 may be attached to the body 128 of the vehicle with a bracket 148 fixed to the body and which may be formed as a clevis for receiving a cylindrical sleeve 149 that is fixed to an end of the motor 130 opposite the leadscrew 140. In this way, the power actuation mechanism 136 may pivot as the nut 142 follows the arcuate path A. In the example embodiment shown in FIGS. 6A, 6B, and 6C, the bracket 148 may be secured to a stake pocket 134 on the body 128 adjacent the bed of the vehicle. In an alternative arrangement shown in FIG. 7, the bracket 148 may be attached to a central portion of the power actuation mechanism 136, and may be secured to a vertical structural member 129 of the body 128 of the vehicle. In this way, the power actuation mechanism 136 may still pivot as the nut 142 follows the arcuate path A, but may require less longitudinal space within the body 128 of the vehicle.

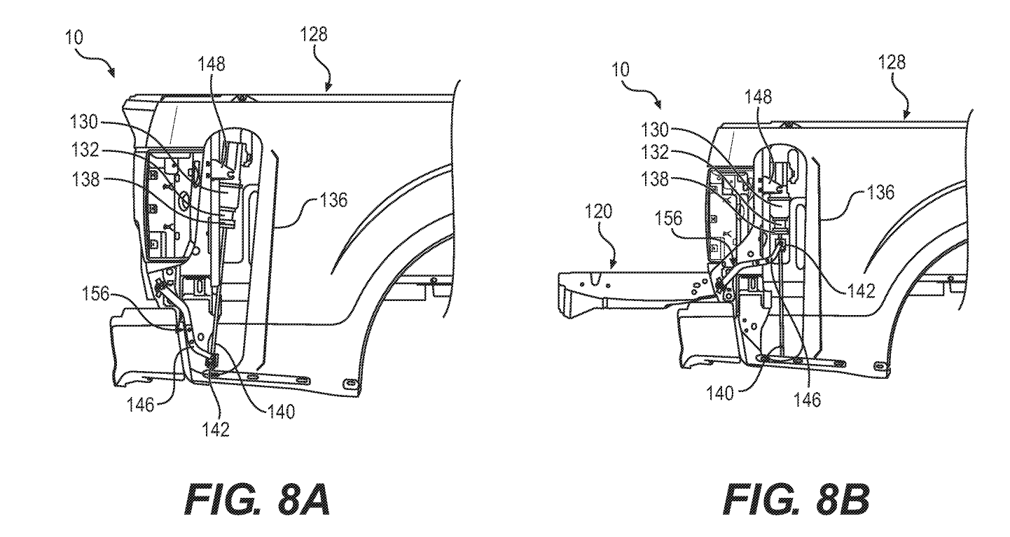

As shown in FIGS. 8A, and 8B, the lever 156 extending from the tailgate 120 may be provided with a complex curve such as, for example, a Z-shape, which may to allow the system 10 to meet packaging requirements such as providing clearance for other devices or structures such as a bumper. Levers 156 having different shapes may be used to allow the system 10 to be incorporated into existing designs or where design constraints limit the space available for the various components of the system 10. The end 146 of the lever 156 may include one or more bends which may comprise part or all of the curves in the lever 156. In other respects, the Z-shaped lever 156 may be configured to function similarly to the L-shaped lever 156 described above.

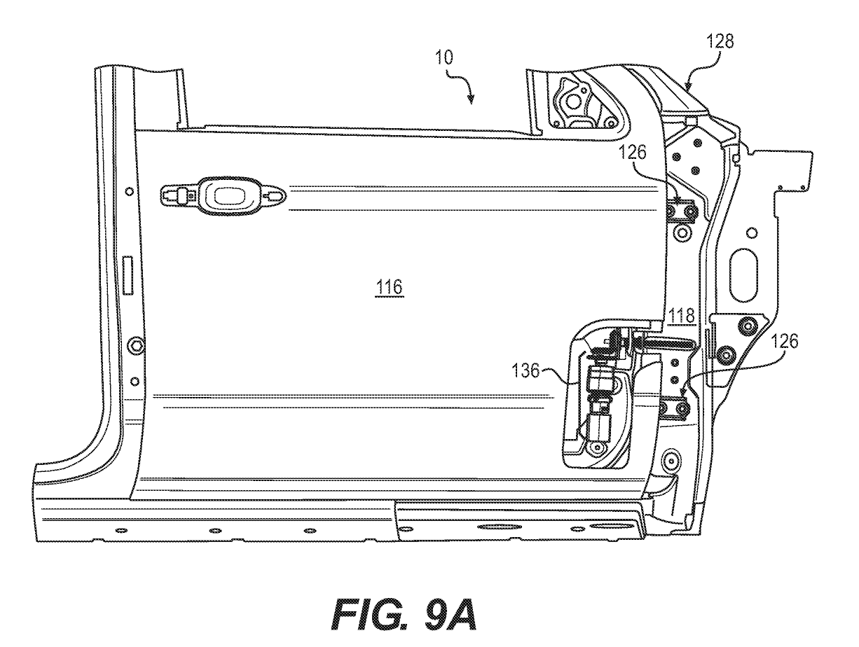

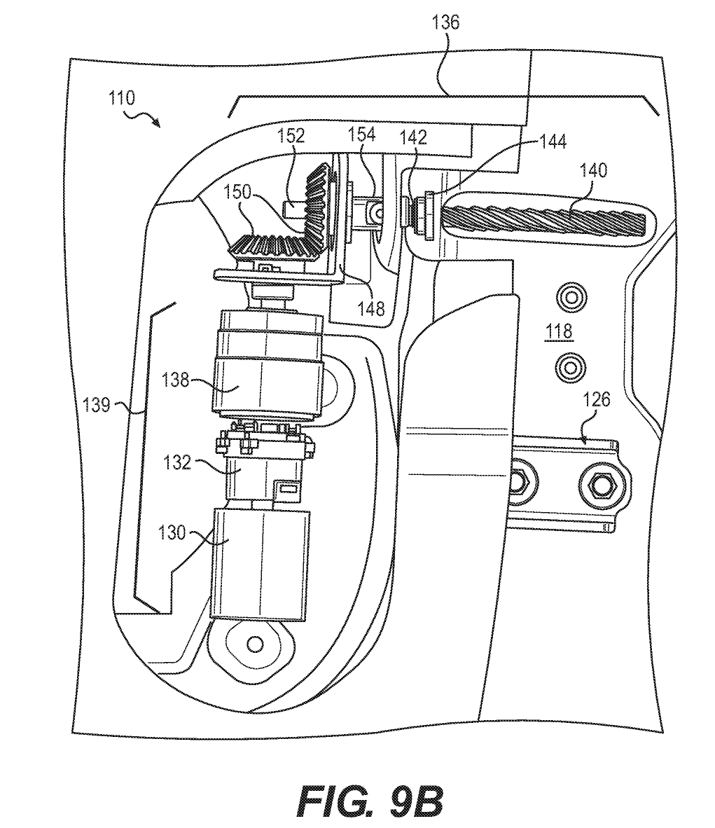

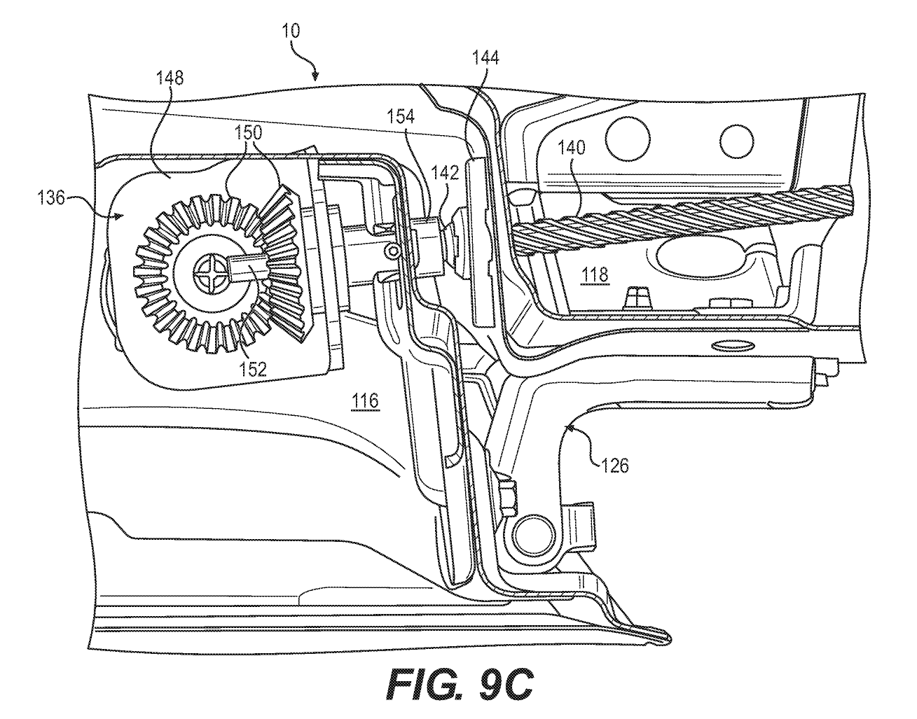

As shown in FIGS. 9A, 9B, and 9C, the system 10 may be used to actuate a vehicle closure which is a side door 116 attached to a vertical pillar 118 of the vehicle with a hinge 126. The power actuation mechanism 136 may be contained within the side door 116 and be coupled to a leadscrew 140 that threadedly interacts with a nut 142 fixed to the vertical pillar 118 to apply a linear force therebetween. It should be noted that the arrangement shown in FIGS. 8A, 8B, and 8C may be reversed such that the power actuator 139 is located within the vertical pillar 118 or another portion of the body 128 of the vehicle, and with the nut 142 fixed to the side door 116 of the vehicle. The arrangement shown in FIGS. 9A, 9B, and 9C may be amended to be used with other types of vehicle closures such as sliding doors, windows, or panels. It may also be used with other types of hinged closures such as, for example, liftgates or gull-wing style doors.

As most best shown in FIGS. 8B and 8C, the power actuation mechanism 136 is fixed to the door with a bracket 148 and includes a pair of bevel gears 150 to translate the rotational movement from the power actuation mechanism 136 90-degrees from a generally vertical direction to a drive shaft 152 extending generally horizontally. A joint 154, which may be, for example, a universal joint, may couple the drive shaft 152 to the leadscrew 140 to transfer generally horizontal rotary motion therethrough, while allowing the leadscrew 140 to pivot about a generally vertical axis to accommodate the motion of the leadscrew 140 as the side door 116 moves between the closed and opened positions. A holder 144 may be fastened to the vertical pillar 118 and may hold the nut 142 from rotating about a horizontal axis, while allowing the nut 142 to pivot about a generally vertical axis to accommodate the motion of the leadscrew 140 as the side door 116 moves between the closed and opened positions.

Obviously, many modifications and variations of the present invention are possible in light of the above teachings and may be practiced otherwise than as specifically described while within the scope of the appended claims.

What is claimed is:

1. A system for opening and closing a closure of a vehicle and comprising:
a motor coupled to the closure through an output linkage and operable to move the closure between a closed position and an open position; and
a high-bandwidth clutch having a dynamic response of greater than 10 Hz selectively coupling the motor with the closure.

2. The system for opening and closing a closure of a vehicle as described in claim 1, wherein said high-bandwidth clutch has a dynamic response of greater than 25 Hz.

3. The system for opening and closing a closure of a vehicle as described in claim 1, wherein said high-bandwidth clutch is a magnetorheological fluid clutch.

4. The system for opening and closing a closure of a vehicle as described in claim 1, wherein said output linkage includes a leadscrew to threadedly engage a nut.

5. The system for opening and closing a closure of a vehicle as described in claim 4, wherein said leadscrew has a lead greater than or equal to 50 mm per revolution.

6. The system for opening and closing a closure of a vehicle as described in claim 4, wherein said leadscrew has a lead less than or equal to 60 mm per revolution.

7. The system for opening and closing a closure of a vehicle as described in claim 1, wherein said output linkage includes a driven pulley.

8. The system for opening and closing a closure of a vehicle as described in claim 1, wherein said closure is a tailgate and wherein said output linkage includes a lever arm.

9. The system for opening and closing a closure of a vehicle as described in claim 8, wherein an area above and beside the tailgate in the open position is unobstructed.

10. The system for opening and closing a closure of a vehicle as described in claim 1, wherein said motor is disposed within the closure of the vehicle.

11. The system for opening and closing a closure of a vehicle as described in claim 1, wherein said motor is disposed outside of the closure of the vehicle.

12. The system for opening and closing a closure of a vehicle as described in claim 1, wherein said system is configured to hold said closure in one of an opened position or a closed position or an intermediate position between said opened position and said closed position.

13. The system for opening and closing a closure of a vehicle as described in claim 1, further comprising a spring configured to bias the closure in opposition to a force by the motor.

14. The system for opening and closing a closure of a vehicle as described in claim 1, further comprising a gearbox functionally disposed between the motor and the output linkage and configured to reduce an output speed of said motor by a predetermined ratio.

15. The system for opening and closing a closure of a vehicle as described in claim 4, further comprising a driveshaft driven by said motor; and
a joint coupling said driveshaft with said leadscrew and configured to transmit rotary force therebetween while allowing the leadscrew to pivot relative to said driveshaft.

16. The system for opening and closing a closure of a vehicle as described in claim 4, further comprising a holder configured to prevent said nut from rotating relative to a rotation of said leadscrew while allowing said nut to pivot about an axis generally transverse to the rotation of said leadscrew.

17. The system for opening and closing a closure of a vehicle as described in claim 1, further comprising a pressure sensor configured to generate a signal to selectively engage said high-bandwidth clutch to move the closure in response to a touch of a user.

18. The system for opening and closing a closure of a vehicle as described in claim 1, further comprising a sensor configured to determine an angular location of the closure.

19. The system for opening and closing a closure of a vehicle as described in claim 1, further comprising a rear-view camera configured to recognize a gesture and to provide a signal to operate said motor and to selectively engage said high-bandwidth clutch to move the closure in response to the gesture.

20. The system for opening and closing a closure of a vehicle as described in claim 1, wherein said output linkage includes a bevel gear configured to translate rotational movement by 90-degrees.
